(19) United States
(12) Patent Application Publication
(10) Pub. No.: US 2004/0015393 A1
(43) Pub. Date: Jan. 22, 2004

(54) Method and system using sms notification for facilitating delivery of goods

(76) Inventors: Fatt Chee Fong, Singapore (SG); Hon Chew Lee, Singapore (SG); Xiao Feng Zhang, Singapore (SG); Gunawan Lauw, Singapore (SG); Guangquan Mo, Singapore (SG); Yu Pern Yeh, Singapore (SG)

Correspondence Address: LAWRENCE N. GINSBERG, 21 SAN ANTONIO, NEWPORT BEACH, CA, 92660-9112, US

(21) Appl. No.: 10/380,394

(22) PCT Filed: Sep. 11, 2001
(86) PCT No.: PCT/SG01/00186

(30) Foreign Application Priority Data
Sep. 13, 2000 (SG) 200005203

(51) Int. Cl. G06F 17/60

(52) U.S. Cl. 705/13; 705/9

(57) ABSTRACT

The present system facilitates delivery of goods by providing a locker module at a location near a customer's residential site. For a vendor to deliver a good to the customer, the vendor leases a unit in the locker module from the system controller by accessing the system controller's web site and providing details of the customer and a delivery agent. The vendor then modifies the delivery agent to make the delivery. The delivery agent provides the system controller the particulars of its delivery person. The designated delivery person accesses the leased locker unit using a registered smart card. The delivery person then places the goods in the designated locker unit. The system controller notifies the customer of the delivered good by sending an SMS message to the customer's mobile phone, the SMS message providing the location of the locker module and a unique pin number. The customer accesses the locker unit by entering the pin number.

### FIELD OF THE INVENTION

The present invention relates generally to the field of goods delivery and storage systems, and in particular, to a method and system for facilitating delivery of transported goods such as parcels, laundry, grocery, etc.

### BACKGROUND OF THE INVENTION

It is a well known fact that many households order goods to b e delivered to their place of residence. The pace of the modern day life is fast. Often, people simply do not have the time to shop. These days, all types of goods can be ordered to be delivered. For instance, many department stores have catalogues where virtually every item sold in the stores can be ordered by mail. Even businesses that traditionally did not previously make regular deliveries such as the groceries or laundries are now offering a delivery service.

Although the convenience of having something delivered to one's home as opposed to traveling to the place where the item is sold can be easily appreciated, the process of receiving the delivered good can be a bit cumbersome. This is because often the agent responsible for delivering the items requires that a person be physically present at the delivery location to receive the goods. Such presence, however, is often not practical, as the deliveries tend to be made during office hours when most people are at work To address these concerns, some prior art locker systems have been developed. In one system, lockers are placed at or near residential sites. The storage units in the lockers have a coded locking mechanism which unlocks when a correct code is entered. The code changes with each use. For a customer to use the lockers to receive a purchased good, the customer inserts a set of coins or swipes a credit card reader which is attached to a locker unit. When the proper amount is registered, a code for opening the locker is given to the customer. The customer then calls the deliverer of the goods and gives him the code. The deliverer brings the purchased good to the locker site and uses the code to open the locker unit. After the good is placed inside the unit, the deliverer locks the unit by closing its door. The deliverer calls the customer to notify him that the good has been placed in the locker unit To access the good, the customer enters the code to unlock the locker unit. After the unit has been accessed twice, the code is no longer valid.

Although this and other types of delivery systems exist, what is needed in the modern days of the Internet and automated deliveries is a more robust delivery system which is intelligent and flexible. Particularly, it would be desirable to have a system which can keep track of all transactions and transacted parties, and which is able to report status of transactions and intelligently keep payment data relating to the transactions. The system should also be reliable, safe and convenient to use. Particularly, it would be useful to have a system where the end customers can use the locker system without requiring any type of registration system, and who can receive the notification of the delivery in a convenient manner. Such a system is currently not available.

### SUMMARY OF THE INVENTION

The present invention is an intelligent and robust system for facilitating a delivery of transported goods. In general, the present system facilitates a delivery of goods by providing a temporary transfer facility where the delivery occurs. The transfer facility will be placed at a location convenient to the customer which, in most instances, will be at high-density residential areas such as an apartment complex. A delivery transaction using the present invention typically involves four main parties: a customer who is a purchaser of a good; a vendor who is the seller of the good; a delivery agent who is the deliver of the good; and a system controller which is the facilitator of the delivery transaction.

The transfer facility is an intelligent computer-controlled locker module which is remotely and wirelessly connected to a system controller (though it can also be connected via a landed wire). Each of the locker modules can receive and send out signals to communicate with the system controller. The system controller is also linked with the customer's mobile phone or pager via the short message service (SMS) network, and with the vendor's PC and the delivery agents PC preferably via the Internet. Via the Internet linkage, the parties can handle various transactions such as registration, leasing, checking of status, etc.

Before a delivery can be made using the present system, the vendor, and delivery agent are registered with the system controller where they provide their particulars and register a smart card and a pin number. For the delivery agent, it registers itself as a company as well as the individual persons who will be making the delivery.

In scenario, the registered vendor leases a locker unit of appropriate size from a locker module located near the customer's home via the Internet. During the leasing process, the vendor provides the required details of the customer and the delivery agent so that the respective parties can access the leased locker unit. The vendor then notifies the registered delivery agent to deliver the good to the specified locker unit of the specified locker module. The delivery agent then sends a registered delivery person to the site of the locker module, who uses a registered smart card to access the specified locker unit to drop off the goods into the locker unit. By sending an SMS message to the mobile phone or pager of a customer, the system controller notifies the customer that the delivery has been made and that he should pick up the delivered good. The customer accesses the locker unit by entering a pin number provided in the SMS message.

In a second scenario, no locker reservation is made. When the vendor informs the delivery agent to make a delivery, the vendor provides the delivery agent the location of the locker module and the customers mobile phone or pager number. A registered delivery person takes the goods to the specified locker module and leases a locker unit at the site. The delivery person provides the mobile phone or pager number to the locker module. By sending an SMS message to the mobile phone or pager of a customer, the system controller notifies the customer that the delivery has been made and that he should pick up the delivered good. The customer accesses the locker unit by entering a pin number provided in the SMS message.

In one embodiment, the method of facilitating a delivery of goods where the method involves a customer, a vendor, and a delivery agent, the delivery agent having a plurality of delivery persons, the vendor having to deliver a good to the customer using the delivery agent comprises the steps of providing a locker module having a plurality of locker units; providing a registration platform for registering the vendor, delivery agent, and at least one delivery person; allowing a registered delivery person to lease a locker unit by having the delivery person provide a set of particulars to the locker module, the particulars including at least a mobile phone number of the customer; providing the registered delivery person access to a locker unit when the particulars are provided to the locker module such that the good may be placed inside the locker unit; sending an SMS message to the mobile phone having the entered mobile phone number, the SMS message providing at least a notification to pick up the good, a location of the locker module, and a unique pin number; and allowing a person access to the locker unit containing the good when the unique in number is provided to the locker module.

In another embodiment, the method of facilitating a delivery of goods where the method involves a customer, a vendor, and a delivery agent, the delivery agent having a plurality of delivery persons, the vendor having to deliver a good to the customer using the delivery agent comprises the steps of providing a locker module having a plurality of locker units; providing a registration platform for registering the vendor, delivery agent, and at least one delivery person; allowing a registered vendor to lease a locker unit by having the vendor provide a set of particulars to the locker module, the particulars including at least a mobile phone number of the customer; providing a unique transaction number to the vendor; providing the registered delivery person access to a locker unit when the transaction number is provided to the locker module such that the good may be placed inside the locker unit; sending an SMS message to the mobile phone having the entered mobile phone number, the SMS message providing at least a notification to pick up the good, a location of the locker module, and a unique pin number; and allowing a person access to the locker unit containing the good when the unique pin number is provided to the locker module.

### BRIEF DESCRIPTION OF THE DRAWINGS

FIG. 1 is an overall block diagram illustrating the preferred embodiment of the present delivery and pick-up system.

FIG. 2 illustrates the physical layout of the locker module.

FIG. 3A is a schematic block diagram illustrating the circuitry components of the locker module shown in FIG. 2.

FIG. 3B is a block diagram illustrating the major components of the system controller.

FIG. 4 is a diagram showing the relationships of the parties involved in a delivery transaction.

FIG. 5 is a simplified flow diagram illustrating the steps one embodiment for facilitating a delivery transaction.

FIG. 6 is a simplified flow diagram illustrating the steps for another embodiment for facilitating a delivery transaction.

FIG. 7A is a flow diagram illustrating the steps for registering a corporate user of the present system.

FIG. 7B is a flow diagram illustrating the steps for registering a corporate user's delivery persons.

FIG. 8 is a flow diagram illustrating the steps for activating a smart card at a locker module site.

FIG. 9 is a flow diagram illustrating the steps for reserving a locker unit.

FIG. 10 is a flow diagram illustrating the algorithm employed by the system controller and locker module controller whenever a smart card is inserted into a locker module.

### DETAILED DESCRIPTION OF THE INVENTION

In general, the present system facilitates a delivery of goods by providing a temporary transfer facility where the delivery occurs. The transfer facility will of course be placed at a location convenient to the customer picking up the good which, in most instances, will be at high-density residential areas such as an apartment complex, though other areas such as a train station is also possible. In the preferred embodiment, the transfer facility is an electronic locker module which provides selective access to the appropriate parties. The preferred embodiment of the present invention utilizes the concept of lease where the party wishing to use the locker for delivery “leases” a unit in the locker module on fixed short-term duration until the delivery or the pickup is made.

The operation of the present invention involves multiple parties. Typically, in a delivery scenario, the parties would include a customer, vendor, delivering agent, and the system controller. The customer is the purchaser of a good. The vendor is the seller of the good. The delivering agent is the entity which is responsible for delivering the good. And lastly, the system controller is the party who facilitates the transactions for the delivery to occur.

Although in general the parties are separate and independent, in some situations, a party can take on multiple identities. For instance, in the case of the delivery scenario, a large seller of goods such as Compaq Corp. may both be a vendor and a delivering agent, provided that the vendor also has the facility for delivery. Also, one party may make up multiple entities. For instance, a delivery agent such as Federal Express may have many delivery persons, each of whom must be registered with the system controller.

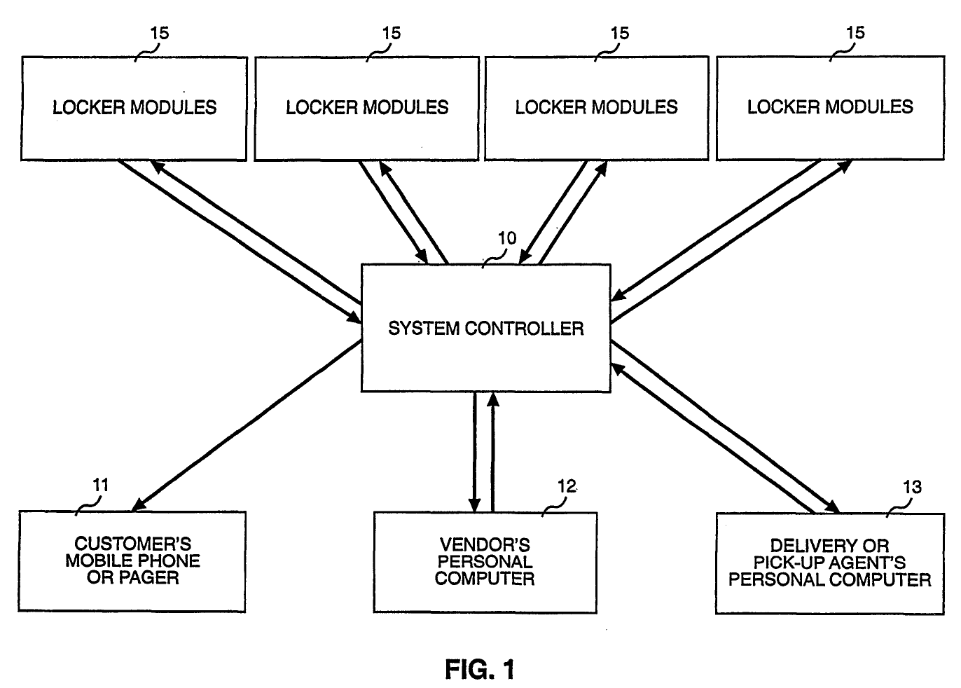

FIG. 1 illustrates the overall system block diagram illustrating the preferred embodiment of the present invention. In this embodiment, the system controller 10 is remotely and communicably (either via a wired line or a wireless channel) linked up with each of the locker modules 15 which are dispersed throughout a particular region. Each of the locker modules 15 can both receive and send out signals to communicate with the system controller 10. The system controller 10 is also communicably linked with the customer's mobile phone or pager 11, the vendor PC 12, and the delivery and pick-up agents' PC 13. In the preferred embodiment, the system controller 10 is linked to the PCs via the Internet and the system controller 10 is linked to the customer's mobile phone or pager 11 via the short message service (SMS) network, though other types of linkages are clearly possible. Via the Internet linkage, the parties can handle various transactions such as registration, leasing, checking of status, etc.

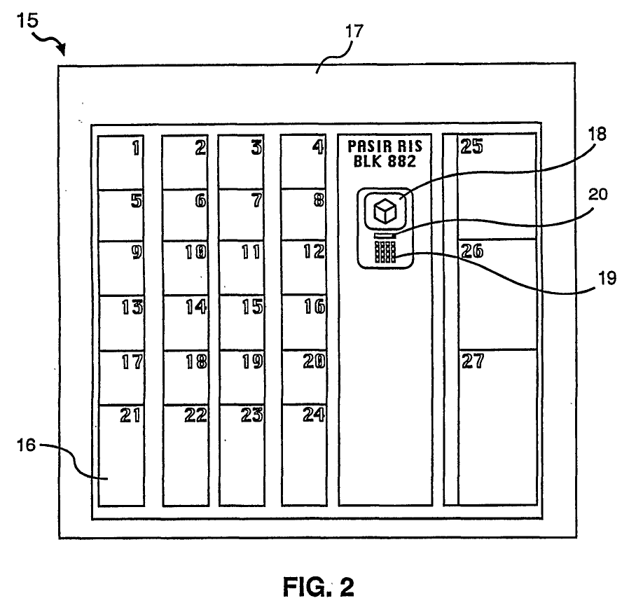

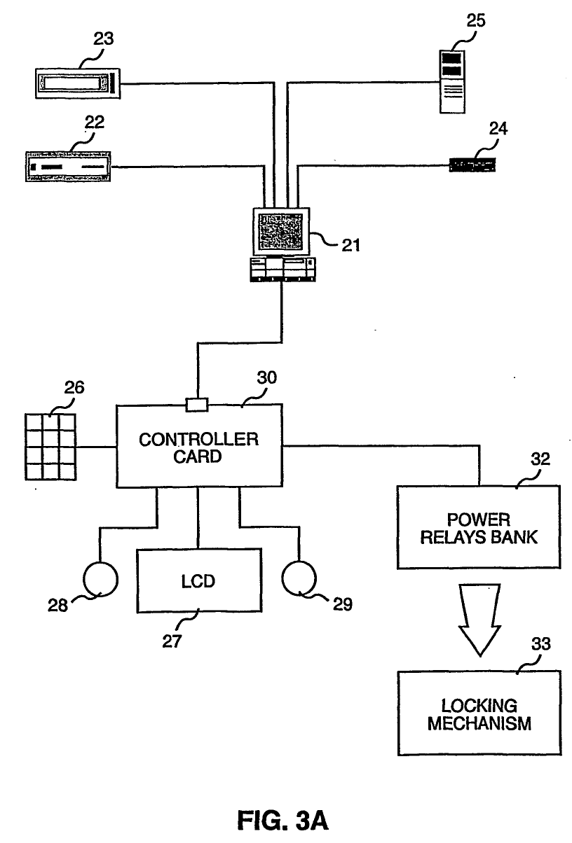

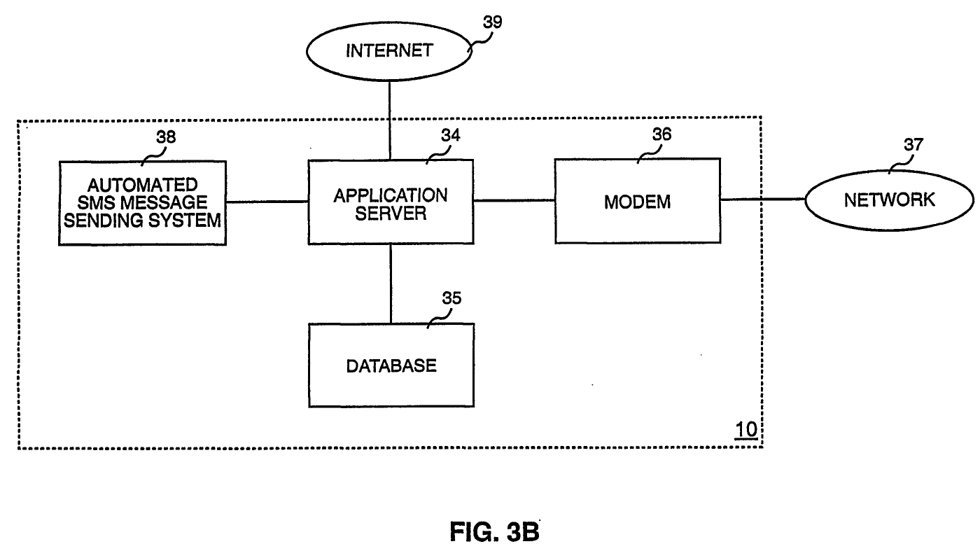

FIG. 2 illustrates the physical layout of the locker module 15 and FIG. 3A illustrates the schematic block diagram of the circuitry for the locker module 15. First referring to FIG. 2, the locker module 15 generally has a sturdy frame 17 and a plurality of locker units 16 with heavy duty security doors which are numbered for easy reference. Each of the doors has a locking mechanism which is controlled by the locker module's main controller. The locker module 15 also comes with a user-interfacing devices such as a computer monitor 18 and a keypad 19 and a card slot 20. In the preferred embodiment, the card slot is adapted to receive smart cards, but can alternatively be made to receive other types of cards such as credit cards, debit cards, etc. Enclosed within the walls of the locker module 15 is the circuitry for controlling the operation of the locker module (shown in FIG. 3A). The locker modules may optionally carry a camera for recording an image of a person using the locker module.

FIG. 3A illustrates in a schematic block diagram, the circuitry for controlling the operation of the locker module which includes a main controller PC 21 which is basically a computer apparatus which will be the locker module controller for handling the logical functions of the locker module. The controller PC 21 has an embedded database which is capable of storing data relating to a transaction. The controller PC 21 is linked to a smart card reader 22 and motorised card acceptor 23 for accepting and reading smart cards. The controller PC 21 is also linked to a wireless modem 24 which can send and receive wireless signals. Although various wireless or wired communication technology such as SMS (short messaging service), paging, radio frequency may be employed, in the preferred embodiment, a wireless Mobitex® modem which employs a proprietary RF technology is used. For wired communication, if one is employed, an ISDN line or cabled lines may be used. Of course, a use of this type of communication medium would require a switch or router which is appropriate for the type of communication line being used.

Still referring to FIG. 3A, the controller PC 21 is further linked to a controller card 30 which interfaces the main controller PC with the keypad 26, left and right momentary switches 28 and 29, respectively, and an LCD monitor screen 27. The keypad 26, and the left and fight momentary switches 28 and 29 are basically input devices for the locker module and the LCD monitor 27 is for display of user information and instructions. The controller PC 21 is further linked to the locking mechanism 33 via the controller card 30 and power relays bank 32 which provide interfacing between the controller PC 21 and the locking mechanism 33 such that the controller PC has full control to lock and unlock the locking mechanism 33 of each locker unit A universal power supply (UPS) is optionally connected to the controller PC 21.

Although a specific implementation was shown in FIG. 3A, it should b e understood that this implementation is illustrative only, and is in no way representative of the only way the present locker module may be implemented. For instance, although in the preferred embodiment, a smart card system is used, it should be understood other types of credentialing method or device which can uniquely identify an individual may be possible. A smart card is a relatively recent device which is a plastic card with a microchip attached to it. As a standard, each smart card has a unique serial number associated with it which is extracted by the present system. By associating a smart card and a pin number to an individual, the smart card is able to uniquely identify a person. Similarly, an identification system such as fingerprint recognition system which can uniquely identify an individual may be used as an alternative to the present smart card system.

FIG. 3B illustrates in a block diagram, the components of the system controller 10 which includes an application server 34 and a database 35. The application server contains all of the programs for controlling the delivery system, and the database stores the data. Some data is stored in the database of the system controller while some data is stored in the embedded database of the locker module controller PC 21 depending on its use. The data stored in the embedded database is periodically backed up to the system controllers database. The application server 34 is linked to Mobitex® modem 36 which is linked to a public wireless network 37 such that it communicates with modem 24 of the locker module (FIG. 3A). Alternatively, the application server 34 may be linked to an ISDN or cable switch if a wired line is used. The application server 34 is also linked to an automated SMS message sending system 38 such that SMS messages can be sent automatically customer's mobile phones, pagers, or other devices capable of receiving an SMS message. Lastly, the application server is connected to the Internet 39 so that customers, vendors, delivery agents, and the like, can access the system controller's web site.

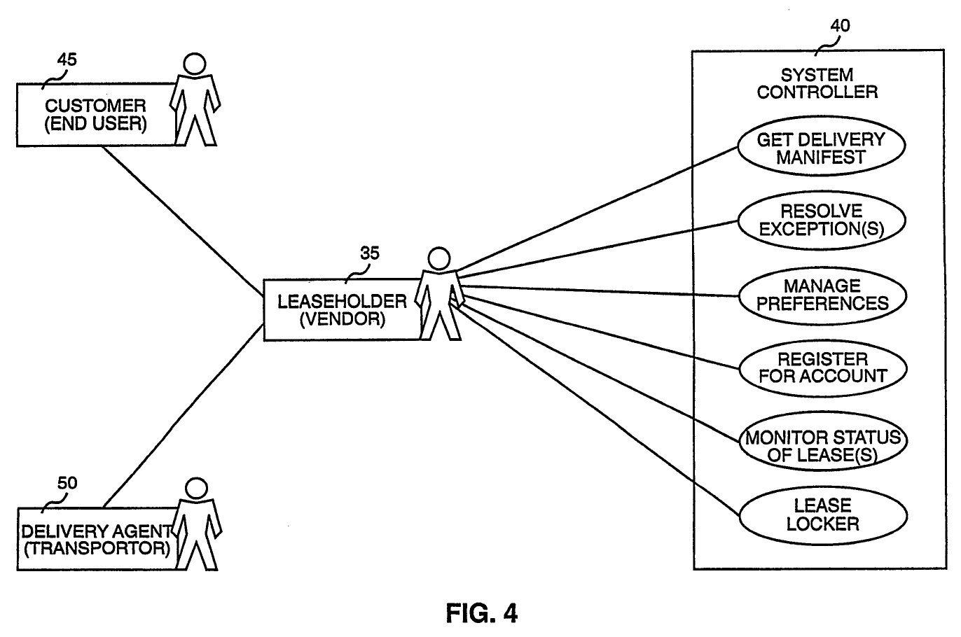

To more clearly illustrate the operation of the present invention, it is useful to define the role of each party and its relationship to the role played b y another party as illustrated in FIG. 4. FIG. 4 illustrates a typical delivery scenario where the vendor 35 is the leaseholder, the customer 45 is the end user, and a third-party delivery agent 50 is the transporter of the goods. The most important of the roles, in a sense, is that of the “leaseholder.” The leaseholder is the party who “leases” a unit in the locker module. In the preferred embodiment of the present invention, either the vendor or the delivery agent can play the role of the leaseholder, though typically, the vendor will be the leaseholder.

As illustrated in FIG. 4, the leaseholder 35, in this case the vendor, has leased a locker unit from the system controller 40 hence it has a direct relationship with the system controller 40. The leaseholder also has a direct relationship with the customer/end user 45 as it has sold goods to him. The leaseholder 40 further has a direct relationship with the delivery agent 50 as the vendor has hired the agent 50 to make the delivery of the purchased good to the leased locker unit The role of the system controller 40 always remains the same—as the facilitator of the transactions. Some of the system controllers main duties are shown in FIG. 4. Among others, the system controller facilitates the registration all of the parties onto its system. It facilitates the leasing of the locker unit to the leaseholder. It also receives the delivery and pick-up manifests, resolves any exceptions, manages preferences, and monitors the status of the lease and the locker module.

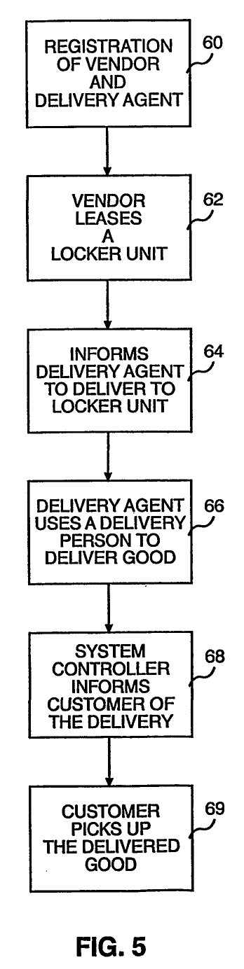

A flow diagram illustrating one of embodiment of the general process flow for facilitating a delivery for the scenario shown in FIG. 4 is shown in FIG. 5. This is a scenario where a customer buys a good from a vendor, and the customer wishes the good to be delivered to his home while no one will be present to receive the good. A locker module of the present invention is located near the customer's home, and he wishes the vendor to deliver the good to the locker module. The vendor will be using an independent delivery agent, e.g. post office, for the delivery. Here, the vendor will make a reservation of a locker unit and inform the delivery agent of the reservation. The FIG. 5 provides only an overview of the delivery transaction; the details of each of the steps in FIG. 5 shall be provided further below.

Referring now to FIG. 5, in step 60, the parties are first registered where the vendor and delivery agent, provide its particulars and register a smart card and a pin number with the system controller. For the delivery agent, it registers itself as a company as well as the individual persons who will be making the delivery.

In step 62, the registered vendor leases a locker unit of appropriate size from the locker module located near the customer's home via the Internet During the leasing process, the vendor provides the required details of the customer, e.g., customer's mobile phone or pager number, and the delivery agent so that the respective parties can access the leased locker unit. In step 64, the vendor then notifies the registered delivery agent to deliver the good to the specified locker unit of the specified locker module. In step 66, the delivery agent sends a registered delivery person to the site of the locker module, who then uses a registered smart card to access the specified locker unit to drop off the good into the locker unit. In step 68, the system controller notifies the customer via the SMS network that the delivery has been made and that he should pick up the delivered good. In step 69, the customer accesses the locker unit by entering a pin number and/or mobile phone number and picks up the delivered good.

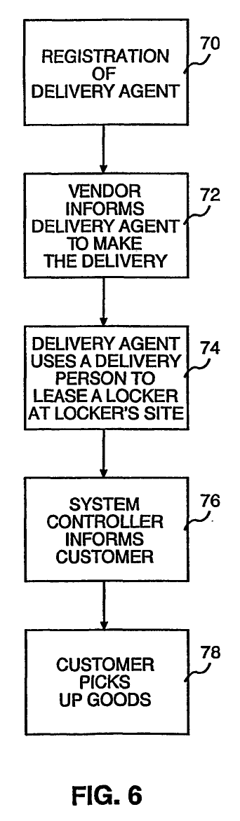

A flow diagram illustrating another embodiment of the general process flow for facilitating a delivery for the scenario shown in FIG. 4 is shown in FIG. 6. This is a scenario where a customer buys a good from a vendor, and the customer wishes the good to be delivered to his home while no one will be present to receive the good. A locker module of the present invention is located near the customers home, and he wishes the vendor to deliver the good to the locker module. The vendor will be using an independent delivery agent, e.g. post office, for the delivery. Here, no prior reservation is made. The FIG. 6 provides only an overview of the delivery transaction; the details of each of the steps in FIG. 6 shall be provided further below.

Now referring to FIG. 6, in step 70, the delivery agent registers a smart card and a pin number with the system controller for its delivery persons. In step 72, the vendor informs the delivery agent to make the delivery. Here, if the vendor is aware of the present locker system, the vendor provides the delivery agent the mobile or pager number of the customer and may even specify the location of the locker module where the delivery needs to be made. In step 74, the delivery agent uses a registered delivery person to make the delivery. If the delivery agent is told by the vendor the mobile phone number of the customer and the location of the locker module, the delivery person goes directly to the locker module location and leases a locker at the site. If the delivery agent was not told of the customer's mobile phone or pager number and the locker module location, the delivery agent may have to obtain this information on its own from the customer. For instance, the delivery agent may first attempt to make the delivery at the customers home. When a delivery person finds the home empty at the time of the delivery, the delivery person may leave a message for the customer to call and provide the customer's mobile number so that the delivery can be made to a specified locker module. In any case, once the mobile or pager number is obtained, the delivery person can lease a locker unit and make the delivery.

In step 76, once the delivery is made, the system controller sends an SMS message to the mobile phone or pager corresponding to the number provided by the delivery person. In step 78, once the customer reads the SMS message, the customer picks up the delivered good using a pin number and/or his mobile phone or pager number.

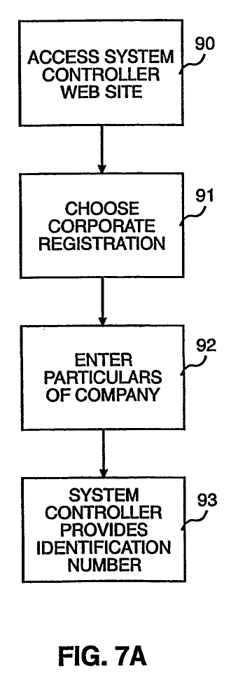

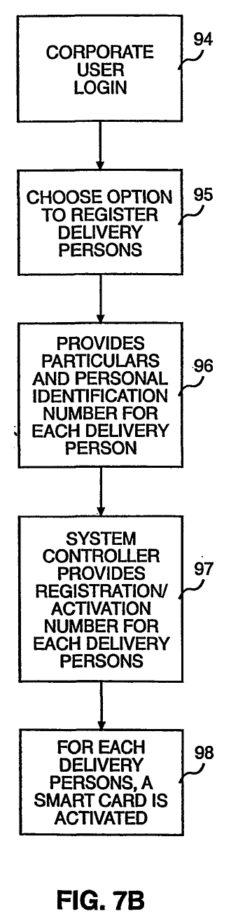

Now the details of the steps shown in FIG. 5 and FIG. 6 shall be described beginning first with the registration process as shown in steps 60 and 70. The purpose of the registration is basically to uniquely identify a party. In the preferred embodiment, the registration process will be conducted via a web site through the Internet, though clearly, other modes of communication is clearly possible. Referring now to FIG. 7A, the registration process begins in step 90 where the corporate user, i.e., vendor or delivery agent, accesses the system controller's web site. In step 91, the user then chooses the corporate registration option. In step 92, the user enters the corporate particulars which may include corporation's name, address, contact person, phone number etc. In the preferred embodiment, the particulars also include login name and a password or pin number. Once the requested information is entered and submitted, the system controller provides the corporate user an identification number identifying the corporation. The corporate user is now registered. The corporate user's registration process may be used either by the vendor or the delivery agent.

Although after executing the steps in FIG. 7A the corporate user is registered, the corporate user may still need to register its delivery persons. This is particularly true if the corporate user is a delivery agent such as UPS or DHL where delivering goods is its main function. However, even if the corporate user is a vendor such as Compaq or IBM where its main function is not necessarily delivery, it may still wish to register its delivery persons if the corporation offers a delivery service. FIG. 7B illustrates the steps for registering the delivery persons.

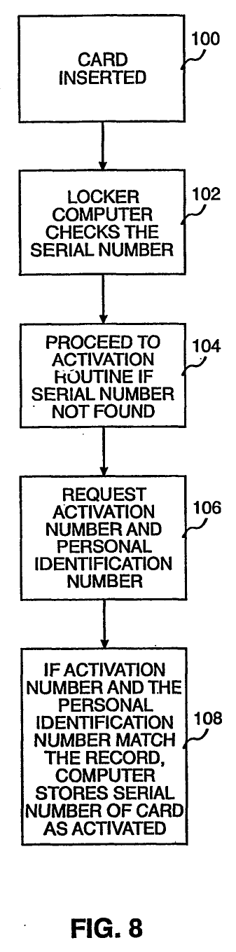

Referring to FIG. 7B, in step 94, the registered corporate user logins at the system controllers web site using its login name and password. If the proper login name and password are entered, the user is given access to various options. In step 95, the corporate user chooses the option to register its delivery persons. In step 96, the corporate user provides the particulars of each of the delivery persons in the fields provided. The particulars may include name, address, etc. In the preferred embodiment, the particulars also include a pin number. Once all of the requested information is submitted, the system controller provides an registration/activation code for each of the delivery persons in step 97. Once the activation code is obtained, a set of smart cards is taken to a locker module site in step 98. At the locker module site, using the pin numbers and the activation codes, the corporate user activates the smart cards per the steps shown in FIG. 8 below.

Referring now to FIG. 8, in step 100, the smart card activation process begins by inserting the card into the provided card slot of the locker module. The locker module controller then, in step 102, reads the unique serial number of the smart card and checks against the appropriate database located either at the system controller site or at the locker module. The activation process only proceeds if the serial number does not exist in the database in step 104 (what happens if the serial number does exist in the database shall be explained later below). If it is found that the serial number does not exist, then the locker module controller requests the activation code and the pin number on the monitor, and the requested information is entered in step 106. The controller remotely checks the code and pin number in the database, and if they are matched, the card is activated, and the serial number of the activated smart card is stored in the database.

A subscription process may optionally be employed after the registration. The subscription process is basically a scheme by which the corporate users choose a particular region of coverage. If the subscription process is employed, the corporate users may only lease the locker modules which are located within the subscribed region. The system controller may base the subscription fee based on the extent of the region of coverage.

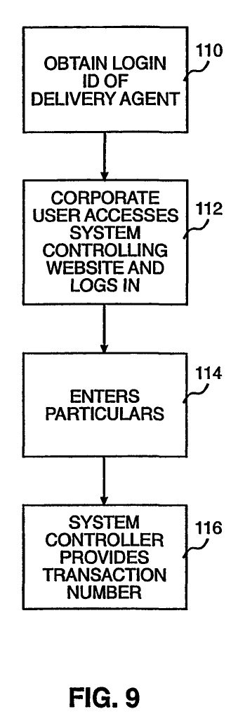

Referring to steps 62 in FIG. 5, once the parties are registered per the steps shown above, a locker unit may be leased by a corporate user (including the delivery agent). FIG. 9 illustrates the preferred process for a corporate user to lease a locker unit In step 110, the corporate user obtains the login identification number (or “login ID”) of the delivery agent. The delivery person's login identification number need not be known at this point, but may be entered if it is available. In step 112, the corporate user accesses the system controllers web site, enters the proper login ID and password, and chooses the option to reserve a locker unit. In step 114, the corporate user provides the particulars requested by the system controller. In the preferred embodiment, the particulars are the delivery agents login ID, the location of the locker module, size of the locker unit needed, the date of the lease, duration of the lease, and the customer's mobile or pager number. Alternatively, the mobile or pager number may be entered at the locker site itself. A pre-made set of selections may be provided for the location of the locker module and the size of the locker unit. Once, all of the information is provided, the system controller provides the corporate user with a unique transaction number in step 116 and reserves the designated locker unit and the designated locker module at the designated date. The lease is good for a specified duration.

Now referring to step 64 of FIG. 5, the vendor notifies the delivery agent of the delivery. Besides the usual information provided to a delivery agent, e.g., company particulars, the vendor provides a unique transaction number to the delivering agent. The vendor may communicate this information in any way which is convenient to the parties.

Now referring to step 66 of FIG. 5, using the transaction number, the delivery agent accesses the vendor's locker reservation request site on the system controller's web site. From the site, the delivery agent is able to ascertain the both the location and the time of delivery as the transaction number will allow it to access the lease information. Once there, the delivery agent enters the login ID of the delivery person who will be making the delivery to complete the lease transaction. All of the lease information is sent by the system controller to the locker module carrying the leased locker unit. The locker module controller then uses the information to provide selective access to the leased locker unit. To make the delivery, the designated delivery person takes his designated smart card to the designated locker module site on the designated date. Once there, he inserts the card into the slot provided. The locker controller reads the unique serial number of the card and after conducting a series of checks (to be explained later) asks for the delivery person's pin number on the monitor. The locker controller opens the leased locker unit only if the proper pin number is entered via the provided keypad.

Now referring to step 68 of FIG. 5, once the delivery is made and the leased locker unit's door is properly closed, the status of the transaction is remotely sent by the locker controller to the system controller. The system controller is now aware that the delivery has been made. The system controller then notifies the customer that the delivery has been made and that the good is ready to be picked up. The notification is sent as an SMS message to the mobile phone or pager number provided by the customer and which was entered by the vendor during the locker reservation. The SMS message can include, among others, a note that a delivery has been made, the location of the locker module, when the lease will expire, a pin number, and a telephone number to call for help (if help is needed).

Now referring to step 69 of FIG. 5, when the customer receives the message that the good is ready, the customer goes to the locker module site. Once at the locker module, the customer enters the pin number provided in the SMS message. The locker module may optionally ask for the customer mobile phone number for additional security. When the proper pin number is entered, the leased locker unit opens for the customer to pick up the good. After the good is picked up by the customer and the locker door is properly closed, the status is transmitted by the locker controller back to the system controller. The delivery transaction is now completed.

The locker leasing process for the step shown in step 74 of FIG. 6 is somewhat different than that shown in step 62 for FIG. 5. In step 74, when the delivery person inserts his smart card into the locker module, by reading the serial number of the smart card and matching it against the database, the locker controller is aware that no prior locker reservation has been, and that the delivery agent will be leasing a locker unit. Assuming that the delivery person's smart card has been properly registered, the locker module prompts the person to enter his pin number. If a proper pin number is entered, it prompts the delivery person to enter the mobile phone or pager number of the customer. Once the number is entered, the person is prompted to enter the particulars of the lease and the delivery which can include, among others, the size of the locker needed, duration of the lease, and the delivery order number (for delivery agents own records). When all the information is entered and confirmed, the appropriate locker unit opens. After the delivery person places the goods inside the locker unit and properly closes the door, the module asks if any additional transactions are needed. Once confirmed “no”, the lease transaction ends, and the smart card is returned back to the delivery person. The steps 76 and 78 of FIG. 6 are identical to the steps 68 and 69 of FIG. 5.

For the delivery transactions to be executed smoothly and safely, the system controller in conjunction with the locker module controller performs a number of administrative tasks both during and apart from the transactions which shall now be described.

The system controller maintains a large database of the registered users. The database is well catalogued so that the particulars of the users can be readily accessed. During the registration process, the system controller ensures that no identical login names exist. Also, during the smart card activation process, the system controller ensures that a smart card having a serial number which already exists in the database cannot be reactivated.

When a locker reservation is requested, the system controller checks the integrity of all of the necessary entered particulars. First, it ensures that the corporate user making the reservation is properly registered by matching the login name and the password with that in the system controllers database. Same is done for the entered delivery agents ID, and the delivery person's ID. When the locker module and the locker unit size are specified, the system controller checks against other reservations to make certain of its availability. If the locker unit is not available, the corporate user is so notified.

When the corporate user makes a selection, the system controller defines a set of expected actions from the expected parties. So for instance, when a delivery reservation is made (and assuming that the delivery person's ID has been properly entered), the first expected action would be defined as the delivery person making the delivery at the designated locker module during a period assigned for the lease. Therefore, when the correct delivery person slots in his designated smart card at the designated locker module, access will be given to the reserved locker unit. After the delivery, the next expected action is for the designated customer to pick up the good from the locker unit Hence, when the proper pin number is entered at the designated locker module, access will be given to the reserved locker unit. If, however, the customer were to attempt to access the locker unit before the delivery is made, the event would not correspond to the expected action, and therefore, access to the locker unit would not be provided even though the customer entered the correct pin number.

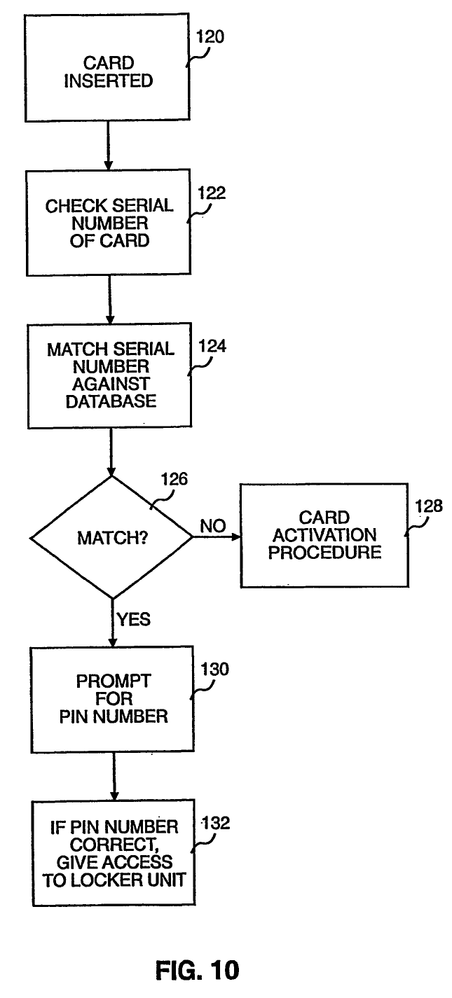

Moreover, for each time a smart card is inserted into a locker module's smart card slot, the system controller in conjunction with the locker module controller conducts a check to ensure that a proper procedure is followed. For instance, among other things, this check ensures that when a new user's smart card is entered, the locker module controller follows the procedure for activating the card. The flow diagram illustrating the preferred process is shown in FIG. 10. First, in step 120, the smart card is inserted into the reader. The serial number of the smart card is read in step 122. The serial number is then matched against the appropriate database, usually the database in the locker module, to see if any pending transaction exists. If a match is not found in step 126, then the card activation procedure is followed (unless the card has already been activated previously). If a match is found in step 126, the pin number is prompted in step 130. If the entered pin number is correct, access is given to the locker unit in step 132.

The system controller keeps tack of all transactions and stores the transaction details in its databases. Some are stored in the database of the system controller while some data is stored in the embedded database of the locker module controller PC depending on its use. The data stored in the embedded database is periodically backed up to the system controller's database. If at any time, a user Wishes to obtain the status of a transaction, he may do so by accessing the system controller's web site and choosing the status option. In addition, the system controller stores the past transactions for a limited period. Hence, if a delivery agent, for instance, wishes to obtain a delivery record of a particular delivery person, it may do so. The corporate user can also update any delivery person details at the web site.

The system controller also keeps track of the payments on a lease-by-lease basis. Although a number of payment schemes are possible using the present system including deducting payment from the smart card at the locker module site, the preferred embodiment of the present invention charges a payment only to the leaseholder by keeping track of the number of locker reservations made and billing the leaseholder on a billing cycle.

The system controller has a procedure for a number of events which are deviant from the norm. For instance, if a delivery person makes a wrong delivery and needs to access the locker unit again, a recovery procedure is followed where the delivery person or the delivery agent must call a person at the system controller site to allow the delivery person special access to the locker unit. Similar procedure is followed if a delivery person were to place the wrong items in the locker unit during a delivery transaction. If the expected delivery or pick-up is not made within the expected time frame, the leaseholder is contacted to renew the lease.

If at any point the system controller loses communication with a locker module, it determines the source of the problem by checking the communication status of the other locker modules. If it is deemed that the source of the problem is at a particular locker module, a serviceman is sent to rectify the problem.

The present invention may be embodied in other specific forms without departing from the spirit or essential characteristics thereof. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein.

I laim:

1. A locker system for facilitating a delivery of goods comprising:
a locker module having a plurality of locker units, a locker controller, a user interfacing device, a credentialing device, and a device for receiving and transmitting signals;
a system controller having an application server, a database, a device for receiving and transmitting signals for communicating with said locker module, and a device for automatically sending out SMS messages, said application server communicably connected to a network.

2. The locker system as recited in claim 1 wherein said network is Internet.

3. The locker system as recited in claim 1 wherein said credentialing device is a smart card reader.

4. The locker system as recited in claim 1 wherein said user interfacing device is a computer monitor and a keypad.

5. A method of facilitating a delivery of goods, said method involving a customer, a vendor, and a delivery agent, said delivery agent having a plurality of delivery persons, said vendor having to deliver a good to said customer using said delivery agent, said method comprising:
providing a locker module having a plurality of locker units;
providing a registration platform for registering said delivery agent, and at least one delivery person;
allowing a registered delivery person to lease a locker unit by having said delivery person provide a set of particulars to said locker module, said particulars including at least a mobile phone number of said customer;
providing said registered delivery person access to a locker unit when said particulars are provided to said locker module such that said good may be placed inside said locker unit;
sending an SMS message to a mobile phone having said entered mobile phone number, said SMS message providing at least a notification to pick up the good, a location of said locker module, and a unique pin number; and
allowing a person access to said locker unit containing said good when said unique pin number is provided to said locker module.

6. A method of facilitating a delivery of goods, said method involving a customer, a vendor, and a delivery agent, said delivery agent having a plurality of delivery persons, said vendor having to deliver a good to said customer using said delivery agent, said method comprising:
providing a locker module having a plurality of locker units;
providing a registration platform for registering said vendor, delivery agent, and at least one delivery person;
allowing a registered vendor to lease a locker unit by having said vendor provide a set of particulars to said locker module, said particulars including at least a mobile phone number of said customer;
providing a unique transaction number to said vendor;
providing said registered delivery person access to a locker unit when said transaction number is provided to said locker module such that said good may be placed inside said locker unit;
sending an SMS message to the mobile phone having said entered mobile phone number, said SMS message providing at least a notification to pick up the good, a location of said locker module, and a unique pin number; and
allowing a person access to said locker unit containing said good when said unique pin number is provided to said locker module.
